(19) United States
(12) Patent Application Publication
(10) Pub. No.: US 2008/0002024 A1
(43) Pub. Date: Jan. 3, 2008

(54) Mobile data-processing handset

(75) Inventor: Michael Schweers, Meerbusch (DE)

Correspondence Address: K.F. ROSS P.C., 5683 RIVERDALE AVENUE, SUITE 203 BOX 900, BRONX, NY, 10471-0900, US

(73) Assignee: Schweers Informationstechnologie GmbH

(21) Appl. No.: 11/474,515

(22) Filed: Jun. 23, 2006

(30) Foreign Application Priority Data
Jun. 29, 2005 (EP) 05014006.0

(51) Int. Cl. H04N 7/00; H04N 5/228; H04N 7/18

(52) U.S. Cl. 348/61; 348/148; 348/222.1; 348/552; 455/344; 348/E05.031; 348/E05.103; 348/E05.114

(57) ABSTRACT

The invention relates to a mobile data-processing handset for processing violations of rules or the like, detected by an operator, particularly for acquiring violations of public-order regulations such as, e.g. traffic rules during the monitoring of stopped and/or moving traffic, with a housing having a front and a rear and containing a data-processing unit, in the front of which both an input device for inputting data and/or operating the data-processing handset and a display device for outputting image and/or processing and/or control information are provided. To specify a mobile data-processing handset which provides for simple handling and uncomplicated operation, a digital image acquisition device, constructed, in particular, as digital camera, is to be allocated to the mobile data-processing handset, and in the front of the housing at least one further display device for outputting-image and/or processing and/or control information is to be provided and to be connected to the digital image acquisition device.

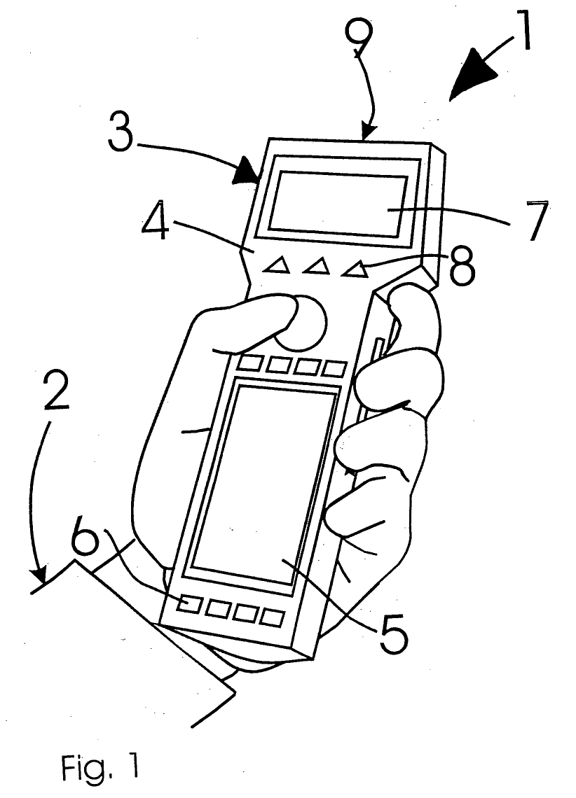

The invention relates to a mobile data-processing handset for processing violations of rules or the like, detected by an operator, particularly for detecting violations of public-order regulations, such as e.g. traffic rules during the monitoring of stopped and/or moving traffic, with a housing having a front and a rear and containing a data-processing unit, in the front of which both an input device for inputting data and/or operating the data-processing handset and a display device for outputting image and/or processing and/or control information are provided.

Violations of rules or the like can be exclusively detected by the operator himself, e.g. when checking parking permits in parked vehicles or when the operator observes that a dog keeper is not properly removing the excrement of his dog. When a violation of rules or the like is detected, the operator can also use technical aids, however. To detect a violation of speed limits by a vehicle driver, for example, a laser pistol, a light barrier or the like can be used as aids.

From practical applications, the most varied data-processing devices are known which in some cases can also be used for detecting and processing data outside of buildings, i.e. “on site”. In most cases, such mobile systems may be transportable with regard to size and weight, but cannot be held in one's hand for a longer period or carried along by an operator without a special carrying aid.

For monitoring stopped traffic, a handset is known which is of correspondingly small and light-weight construction and which has an input device and a display device.

The disadvantageous factor is here that, on the one hand, the required data, such as e.g. the number plate of a wrongly parked motor vehicle, must be input by hand and, if necessary, a camera for creating photos for unambiguous verification of the traffic offence and possibly a mobile telephone and/or a radio device for any telecommunication which may be required and/or data transfer must be carried along in each case. Thus, both the “transport effort” is distinctly increased and complicated handling is required since the operator must handle and operate two or more separate devices.

It is the object of the invention to avoid the aforementioned disadvantages and to specify a mobile data-processing handset which provides for simple handling and uncomplicated operation.

This object is achieved in that the generic mobile data-processing handset is associated with a digital image acquisition device constructed, in particular, as digital camera, and in the front of the housing at least one further display device for outputting image and/or processing and/or control information is provided and connected to the digital image acquisition device. Furthermore, a communication unit can be allocated for data and voice transmission and possibly voice recording.

In this arrangement, the digital image acquisition device can be connected to the mobile data-processing handset via a line or “wirelessly” by radio, infrared, ultrasound and, particularly, via short-range radio.

A separate display or a mixed display of image and/or processing and/or control information can be provided on at least one of the display devices, particularly in an optionally arbitrarily adjustable manner.

The mobile data-processing handset has a relatively small size so that it can be hand-held by the operator or carried attached to a belt even with relatively long operating periods, particularly for a period lasting several hours, without excessive stresses occurring.

In this respect, the dimensions can be approx. 150×50×30 mm up to 250×100×60 mm and, in particular, 175×60×35 mm on the underside and 230×80 mm on the top. The weight can be 300 to 800 g and particularly approx. 600 g.

To reduce its volume while not in use or when a part-area, such as e.g. the digital image acquisition device is currently not needed, the housing can be advantageously designed to consist of a number of part-areas flexibly connected to one another so as to be foldable. One part-area can be designed to be distinctly smaller compared with the main area of the housing and thus only cover a small proportion when folded up. In particular, the folding up can also take place towards the rear or a sliding mechanism can be provided. In the case of an external digital image acquisition device, a receptacle or a free space for attaching or stowing the image acquisition device can also be provided.

As well, a conventional energy supply by means of a store for electrical energy which, in particular, is rechargeable, is provided.

In this respect, both the transport and the operation is distinctly simplified due to the restriction to a single handset.

The image acquisition device can also be preferably integrated in the housing, particularly in the rear of the housing so that it is not necessary to carry, or at least handle during the image acquisition, a separate element, even if of very small size. The image acquisition device can be arranged, in particular, on the front end or at a side face of the housing. In particular, the corresponding face can have a protruding or obliquely aligned area for this purpose. Usual types of construction such as, e.g. a slightly recessed arrangement or removable or movable cover are naturally possible.

According to the invention, at least one further input device for operating the image acquisition device can be provided in the front of the housing so that a special operating panel is provided for each separate functional unit and multiple key allocations or the like are avoided in this respect and a particularly simple operation of the extensive functions of the mobile data-processing handset is possible.

As well, a further data-processing unit for processing the data of the image acquisition device can be provided in the housing so that, due to the separation of the data-processing units for the different functional units, there is no interaction in the maximum possible performance so that, for example, the data-processing of incoming data is not impaired by image acquisition taking place at the same time.

In a preferred illustrative embodiment of the invention, the image acquisition device can be provided in a delimited, particularly also angled, area of the rear of the housing so that the orientation of the image acquisition is directed towards a normal application, for example the acquisition of motor vehicle number plates or for recording evidence in a usual position of holding the mobile data-processing handset. The orientation of the image acquisition device can also be preferably adjustable, for example for adaptation to the size of the operator or for adjustment to the respective application.

The further display device can also be provided in a delimited, particularly also angled, area of the front of the housing, so that during image acquisition the further display device is directed in its orientation to the viewing angle of the operator during usual image acquisition, for example the acquisition of motor vehicle number plates in a usual position of holding the mobile data-processing handset. The orientation of the further display device can also be preferably adjustable, for example for adaptation to the size of the operator or for adjustment to the respective application.

For this purpose, the further input device can also be provided in a delimited, particularly also angled, area of the front of the housing.

According to the invention, at least one display device can be constructed as touch screen and the corresponding input device can also be formed by this touch screen so that, on the one hand, the space requirement is reduced by combining these two devices and, on the other hand, a particularly simple operation is possible by inserting corresponding menus, possibly identified by symbols, on the touch screen.

Furthermore, a printing unit for printing out information can be integrated in the housing so that acquired data can be output, for example in the form of a record, a receipt or a ticket, or of a recording made by the image acquisition device, in written form or as printed photo.

As well, the acquisition system can also be used as mobile communication unit for data and voice and as voice recording system. For this purpose, the device is equipped with at least one communication unit each, a loudspeaker and a microphone. In this arrangement, microphone and loudspeaker can be optionally accommodated on the front or rear, on the side or top or bottom in the housing.

In the text which follows, an illustrative embodiment of the invention shown in the drawing is explained, in which:

the single FIGURE shows a mobile data-processing handset 1 for processing information by an operator 2 shown only in outline in the drawing.

In the drawing, the handset 1 has a housing 3 with a front 4 and a rear, not shown in the drawing. In the front 4, both a first display device 5 and a first input device 6 and a second display device 7 and a second input device 8 are provided. In each case, these are combined to form functional units with respect to their position and are correspondingly arranged next to each other.

In a preferred embodiment, the first display device 5, together with the first input device 6, is exclusively provided for data input and for operating the mobile data-processing handset 1, whereas the second display device 7 with the second input device 8 is intended for operating a digital image acquisition device 9 provided at the front end not shown in the drawing.

1. Mobile data-processing handset (1) for processing violations of rules or the like, detected by an operator (2), particularly for acquiring violations of public-order regulations, such as e.g. violations of traffic rules during the monitoring of stopped and/or moving traffic, with a housing (3) having a front (4) and a rear and containing a data-processing unit, in the front (4) of which both an input device (6) for inputting data and/or operating the data-processing handset (1) and a display device (5) for outputting image and/or processing and/or control information are provided, characterized in that a digital image acquisition device (9), constructed, in particular, as digital camera, is allocated to the mobile data-processing handset (1), and in the front (4) of the housing (3) at least one further display device (7) for outputting image and/or processing and/or control information is provided and connected to the digital image acquisition device (9).

2. Mobile data-processing handset (1) according to claim 1, characterized in that the image acquisition device (9) is also integrated in the housing (3), particularly in the rear of the housing (3).

3. Mobile data-processing handset (1) according to claim 1, characterized in that at least one further input device (8) for operating the image acquisition device (9) is provided in the front (4) of the housing (3).

4. Mobile data-processing handset (1) according to claim 1, characterized in that a further data-processing unit for processing the data of the image acquisition device (9) is provided in the housing (3).

5. Mobile data-processing handset (1) according to claim 1, characterized in that the image acquisition device (9) is provided in a delimited, particularly also angled, area of the rear of the housing (3).

6. Mobile data-processing handset (1) according to claim 1, characterized in that the further display device (7) is provided in a delimited, particularly also angled, area of the front (4) of the housing (3).

7. Mobile data-processing handset (1) according to claim 1, characterized in that the further input device (8) is provided in a delimited, particularly also angled, area of the front (4) of the housing (3).

8. Mobile data-processing handset (1) according to claim 1, characterized in that at least one display device (5, 7) is constructed as touch screen and the corresponding input device (6, 8) is also formed by this touch screen.

9. Mobile data-processing handset (1) according to claim 1, characterized in that a printing unit for printing out information is integrated in the housing (3).

10. Mobile data-processing handset (1) according to claim 1, characterized in that a communication unit for digital or analogue transmission of information is integrated in the housing (3).

11. Mobile data-processing handset (1) according to claim 1, characterized in that a communication unit for digital or analogue transmission of voice is integrated in the housing (3).

12. Mobile data-processing handset (1) according to claim 1, characterized in that a microphone and a loudspeaker for voice input and output are integrated in the housing (3).
